(19) United States
(12) Patent Application Publication
(10) Pub. No.: US 2018/0302403 A1
(43) Pub. Date: Oct. 18, 2018

(54) SYSTEM AND METHOD FOR LOCATION-BASED BIOMETRIC DATA COLLECTION AND PROCESSING

(71) Applicant: Plas.md, Inc., Philadelphia, PA (US)

(72) Inventors: Vance Souders, Camden, NJ (US); Yijie Hu, Camden, NJ (US)

(21) Appl. No.: 15/952,440

(22) Filed: Apr. 13, 2018

Related U.S. Application Data
(60) Provisional application No. 62/484,963, filed on Apr. 13, 2017.

(51) Int. Cl. H04L 29/06; G06N 99/00

(52) U.S. Cl. CPC H04L 63/0861; H04W 76/10; G06N 99/005; H04L 63/107

(57) ABSTRACT

A system for biometric data collection and processing includes at least one biometric sensor associated with a user, the at least one biometric sensor having a biometric data sampling interval and a data broadcast interval, a client device capable of wireless communication and communicatively connected to the at least one biometric sensor, and at least one locator beacon. When the client device wirelessly receives a signal from the locator beacon, the client device changes at least one of the data broadcast interval and the data sampling interval. A method of collecting and analyzing biometric data and a method of virtually pairing a first device with a second device are also disclosed.

### CROSS-REFERENCE TO RELATED APPLICATIONS

This application claims priority to U.S. provisional patent application No. 62/484,963, filed on Apr. 13, 2017, incorporated herein by reference in its entirety.

### BACKGROUND OF THE INVENTION

As wearable devices increase in popularity and decrease in cost, each person is capable of generating an increasing amount of biometric data simply going about their daily activities. In addition to the wide variety of sensors and transmitters packed into smart phones, users increasingly wear Bluetooth® pedometers or heart rate monitors to track fitness data, or smart watches containing their own suite of data-generating sensors. As the amount of data increases dramatically, it becomes more difficult to store and, more importantly, to process the data down to the metrics one might find useful.

With data collection comes privacy concerns, and another related problem arises when trying to strike a balance between user-friendly operation and restricting access to potentially sensitive information. Most wearable devices communicate with Bluetooth® or similar low-power, short range protocols. Intrinsic in Bluetooth® is the “pairing” process of connecting a peripheral (e.g. a heart rate monitor or smart watch) to a host device (e.g. a smart phone or a computer). Pairing typically requires a user to place the peripheral in a “pairing mode”, in which the peripheral consumes more power but also broadcasts its presence to nearby hosts. The user must then select the peripheral device from a list of those visible to the host, and sometimes must also enter a code to validate that she is the owner of both the peripheral and the host. While advantageous for data security, the pairing process can also make it awkward or difficult to pair with a new device, or with a device one wishes to use only for a short time. Bluetooth® or other short-range radio peripherals could be very useful in a variety of short term environments, such as care facilities, taxi cabs, hotel rooms, or public transportation—but the pairing process presents a high barrier for users.

Thus, there is a need in the art for a system of biometric data collection that helps a user collect, store, and compile the data that is important, while also conserving time and power. The present invention satisfies this need.

### SUMMARY OF THE INVENTION

In one embodiment, a system for biometric data collection and processing includes at least one biometric sensor associated with a user, the at least one biometric sensor having a biometric data sampling interval and a data broadcast interval, a client device capable of wireless communication and communicatively connected to the at least one biometric sensor, and at least one locator beacon, wherein, when the client device wirelessly receives a signal from the locator beacon, the client device changes at least one of the data broadcast interval and the data sampling interval.

In one embodiment, the system further comprises a remote server, wherein the client device sends data received from the at least one biometric sensor to the remote server once per data broadcast interval. In one embodiment, the system further comprises an exercise machine, wherein the exercise machine and the client device are virtually paired. In one embodiment, the exercise machine comprises a treadmill. In one embodiment, the system further comprises a machine learning module. In one embodiment, the system further comprises a virtual environment having at least one parameter, wherein the virtual environment changes the at least one parameter in response to data received from the at least one biometric sensor.

In one embodiment, the system further comprises a display device, wherein the display device and the client device are virtually paired, and wherein the display device presents data received from the at least one biometric sensor. In one embodiment, the display device is also granted access to data about a client associated with the client device, wherein the access is revoked when the client device and the display device are no longer virtually paired. In one embodiment, the data about the client comprises electronic medical records.

In one embodiment, the at least one locator beacon comprises a first locator beacon positioned in a first location and a second locator beacon positioned in a second location, the system further comprising a first risk profile associated with the first locator beacon and a second risk profile associated with the second beacon, the risk profiles defining at least one signaling rule, wherein, when the client device wirelessly receives a signal from the first locator beacon, the client device changes at least one of the data broadcast interval and the data sampling interval according to the at least one signaling rule defined by the first risk profile, and when the client device wirelessly receives a signal from the second locator beacon, the client device changes at least one of the data broadcast interval and the data sampling interval according to the at least one signaling rule defined by the second risk profile. In one embodiment, the second risk profile denotes a second location that is more hazardous than the first location, wherein the at least one signaling rule of the second risk profile causes the client device to decrease at least one of the data broadcast interval and the data sampling interval in response to the signal received from the second locator beacon.

In one embodiment, the second location is a bathroom in a dwelling. In one embodiment, the client device further comprises a third risk profile defining at least one signaling rule associated with an external condition, wherein a remote server transmits the third risk profile to the client device when the external condition is met, and when the client device wirelessly receives the third risk profile from the remote server, the client device changes at least one of the data broadcast interval and the data sampling interval according to the at least one signaling rule defined by the third risk profile. In one embodiment, the external condition comprises a high likelihood of icy weather conditions.

The invention further comprises a method of collecting and analyzing biometric data, comprising connecting at least one biometric sensor to a client device capable of wireless communication, sampling an element of biometric data from a client at a biometric data sampling interval, receiving elements of biometric data from the at least one biometric sensor to the client device at a biometric data broadcast interval, transmitting elements of biometric data from the client device to a remote server, determining that the client device is in close proximity to a locator beacon, and changing at least one of the biometric data sampling interval and the biometric data broadcast interval. In one embodiment, the method further comprises virtually pairing a display device with the client device. In one embodiment, the display device is a tablet computer. In one embodiment, the display device is a head-mounted display. In one embodiment, the method further comprises changing at least one parameter of a virtual environment based on an element of biometric data received from the client device.

In one embodiment, the method further comprises virtually pairing a piece of exercise equipment with the client device, transmitting at least one parameter from a piece of exercise equipment to the remote server, and storing the at least one parameter from the piece of exercise equipment in a database corresponding to the at least one element of biometric data received from the client device.

The invention further comprises a method of virtually pairing a first device with a second device, including the steps of, on a first device, receiving a signal from a locator beacon, from the first device, transmitting a characteristic of the signal to a remote server, determining, based on the characteristic of the signal, whether the first device is in close proximity to a second device, then, when the first device is determined to be in close proximity to the second device, opening a data channel from the first device to the second device, via the remote server, wherein the first device and the second device are capable of exchanging data over the data channel without direct wireless communication. In one embodiment, the second device is electrically connected to the locator beacon. In one embodiment, after the first device is determined to be in close proximity to the second device, the method includes the step of presenting a user of the first device or the second device with a verification step to confirm that a virtual pairing connection is desired.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 depicts the use of a treadmill with one embodiment of the invention.

FIG. 2 depicts a user selecting a treadmill from multiple treadmills in accordance with one embodiment of the invention.

FIG. 3 depicts a residential setup of one embodiment of the invention.

FIG. 4 depicts a user receiving medical care in one embodiment of the invention.

FIG. 5 is a data flow diagram of one embodiment of the invention.

FIG. 6 depicts a method of collecting and analyzing biometric data.

FIG. 7 depicts a method of virtually pairing a first device with a second device.

### DETAILED DESCRIPTION

The present invention provides biometric data collection systems and methods for using the same. The biometric data collection systems comprise any of a wide range of connected data collection peripherals, transmitters and receivers, as well as display devices for visualizing or otherwise representing the data collected and processing infrastructure for collecting and analyzing the raw data received from the sensors.

### Definitions

It is to be understood that the figures and descriptions of the present invention have been simplified to illustrate elements that are relevant for a clear understanding of the present invention, while eliminating, for the purpose of clarity, many other elements typically found in the art. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate. Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

### Computing and Networking

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions or other thin client devices as would be understood by those skilled in the art. Software-based features of the present invention as described herein may be written in any programming language, and may be manifested as compiled binary files, interpreted script files, or some combination of those and any other software format known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G or 4G/LTE networks, Bluetooth®, or Zigbee® communication links, or any other method by which one electronic device is capable of communicating with another. In some embodiments, elements of the networked portion of the invention may be implemented over a Virtual Private Network (VPN).

Some aspects of this invention include or enable the “Internet of Things” (IoT), that is, the networked collection and aggregation of data to and from a variety of sensors and output devices, each typically housed in a special-purpose electronic device. Examples of such sensors include heart rate monitors, blood oximeters, GPS receivers, temperature sensors, pressure sensors, humidity sensors, galvanic skin response sensors, position sensors, proximity sensors, ultra-violet (UV) light sensors, blood pressure sensors, eye tracking sensors, cameras, or any other sensor known in the art. The IoT also comprises displays and actuators of varying size and scope, including (but not limited to) smartphone displays, OLED displays, segmented LED displays, smart watches, virtual reality headsets, speakers, buzzers, servo motors, thermostats, smart home equipment, or any other devices capable of being connected to a network. In some embodiments, certain sensors or actuators may be connected to one or more networks through an intermediary single board computer (SBC) or microcontroller. In other embodiments, the sensors or actuators may be standalone, integrated units. The central idea of the Internet of Things is to make it easier to connect multiple devices together in a network so that each device in the network can make use of the data provided by all the others.

Sensor modules in the Internet of Things typically include a digital circuit that periodically samples one or more values, then broadcasts the sampled value to one or more hosts or networks of hosts at regular intervals. The sampling interval tₛ and the broadcasting interval t_{b} may be roughly equal in some examples. In other examples, the time tₛ is much faster than the time t_{b}, and the sensor module may internally buffer one or more samples before sending out several samples at once. There are power advantages to the buffering approach, as most network protocols require a fixed amount of overhead data per transmission. For example, a Bluetooth® Low Energy (BLE) data packet has a fixed 1-byte preamble, 4-byte access address, and a 3-Byte CRC code at the end of the packet. Within this packet, a transmitting device can store anywhere from 2 to 257 bytes of data to be transmitted. This means that a BLE packet containing 1 byte of data might be 9 bytes long (11% data, 89% overhead), whereas a BLE packet containing 100 bytes of data could be 108 bytes long (92.5% data, 7.5% overhead). Supposing the sensor module was a heart rate sensor that collected a heart rate value (storable in one byte) once per second, it would conserve power for the device to store 60 seconds worth of heart rate data at a time, then send the 60 values in a single BLE packet.

Elements of the present application may be described as “virtually paired”. Unless otherwise specified, two devices are considered virtually paired when they are (a) determined to be in close proximity to one another, and (b) able to exchange data with one another through a remote server infrastructure due to that proximity. This is distinguished from the conventional process of pairing used in BlueTooth® and similar wireless systems in that no direct bi-directional communication takes place between the two virtually paired devices prior to being able to exchange data.

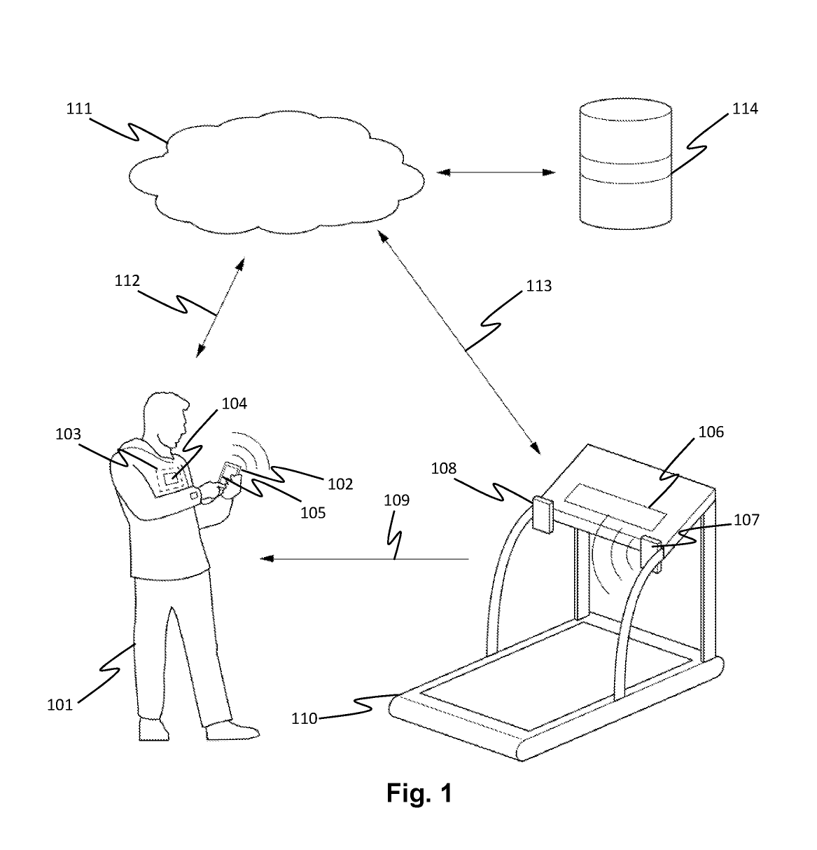

Referring now to FIG. 1, in an exemplary embodiment of the invention, a user 101 is equipped with a network-enabled device 102 that includes or is communicatively connected to at least one sensor. The at least one sensor may optionally be integrated into the network-enabled device, for example an accelerometer 105. The at least one sensor may alternatively be a remote sensor 104 positioned in a separate device 103 communicatively connected to the network-enabled device 102. Some examples of sensors that may be communicatively connected to or included in the network enabled device include a heart-rate sensor, a pedometer, a head orientation sensor, a GPS, a UV light sensor, a skin temperature sensor, an ambient temperature sensor, an ambient light sensor, a blood oxygen sensor, an eye tracking sensor, a magnetometer, and a barometric pressure sensor. In some embodiments, the network-enabled device 102 is a smartphone. The smartphone 102 connects to the internet 111 via a connection 112, which may be any method known in the art of connecting a portable device to the internet including wi-fi or cellular. The exemplary embodiment of the system further comprises a treadmill 110 which has a console 106. Treadmill console 106 may or may not be physically attached to treadmill 110. In some embodiments, treadmill console 106 is communicatively connected to treadmill 110, via either a wired or wireless data connection. The treadmill console 106 connects to the Internet 111 via a connection 113. A beacon 107 is located near the treadmill 110, and periodically transmits a low-power, short-range broadcast signal 109 containing identifying information. The signal 109 is received by the smartphone 102, and is used by the smartphone 102 to determine the user's proximity to this particular treadmill 110.

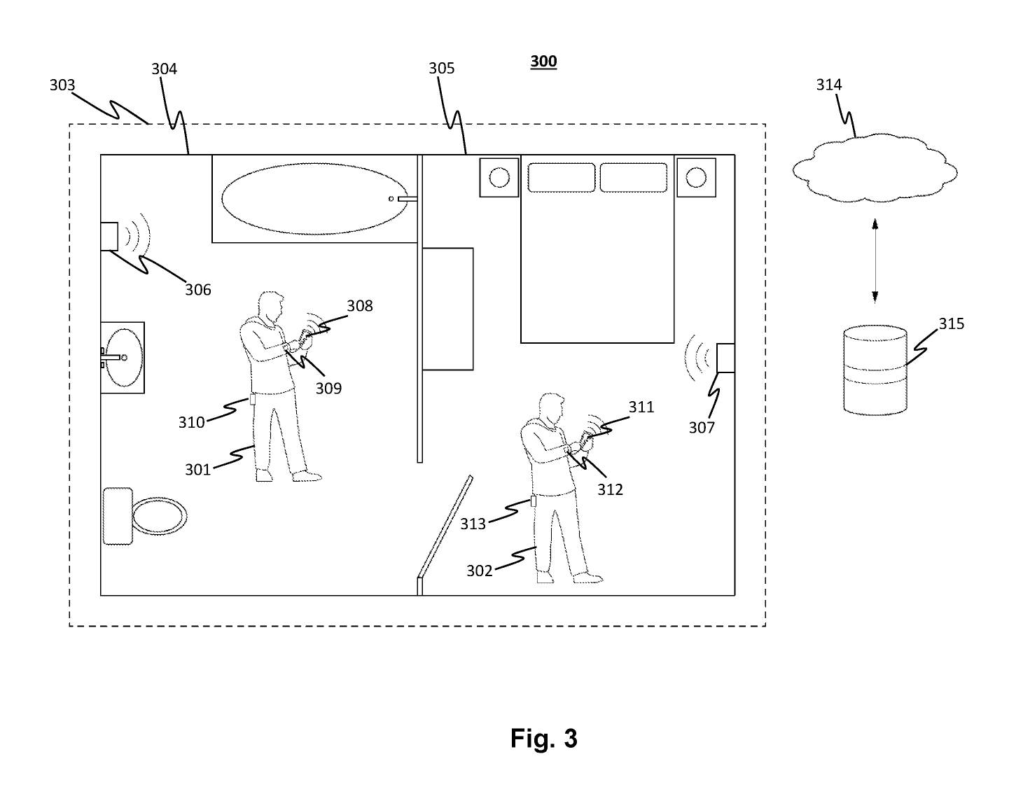

When the smartphone 102 receives the broadcast signal 109, it transmits the identifying information extracted from the signal 109 to the server or servers 114. The smartphone 102 may also transmit other information to the server or servers in order to better pinpoint the location of the user 101. Other information transmitted may include GPS or Assisted-GPS (A-GPS) data, a list of identifiers for cellular towers nearby, a list of wi-fi networks visible to the smartphone, accelerometer/magnetometer data for calculating the orientation of the smartphone, or any other data known in the art to be helpful in determining the location and orientation of a device. In some instances, the location information may be augmented by a further indicator 108 mounted on the treadmill 110. In some embodiments, the indicator 108 is a short range Radio-Frequency Identification (RFID) transmitter. In other embodiments, the indicator is a Quick Repsonse (QR) code that is scanned by the smartphone 102. In other embodiments, the indicator is a light source that can be modulated to communicate with the smartphone 102's ambient light sensor or camera. In other embodiments, the indicator is a colored sticker that is photographed with a camera built into the smartphone 102. In another embodiment, the visual color indicator might be a sticker whose color is presented to the user 101 on the smartphone screen 102 by virtue of user 101's proximity to treadmill 110. In another embodiment, user 101 chooses a color which then blinks on both the smartphone screen 102 and the treadmill 110's display to indicate that the devices are virtually paired. The purpose of the indicator 108 is to more precisely select which treadmill 110 the user 101 is about to use, in case several treadmills 110 are available next to one another and the available location information is insufficient to determine which one the user 101 is about to use (see FIG. 3).

Once the server 114 has identified which treadmill 110 the user 101 is about to use, the server 114 initiates a connection between the smartphone 102 (and by extension, the biometric sensors 104, 105) and the treadmill console 106. In some embodiments, data from the biometric sensors 104, 105 is displayed on the treadmill console 106 during the user's 101 workout. In some embodiments, the parameters of the treadmill are changed automatically based on data received from the biometric sensors 104, 105. In some embodiments, treadmill parameters changed include incline and speed. In some embodiments, the treadmill's 110 parameters are stored, along with the biometric data from the biometric sensors 104, 105 on the server 114 indexed to the user 101. In some embodiments, the data is stored with timestamps.

While the example presented in FIG. 1 includes a smartphone 102, it is understood that the function of the smartphone 102 could be performed by any other device capable of communicating with the biometric sensors and the Internet. Examples include a tablet computer, a laptop, or some other specialized embedded computing device that includes all the requisite communication interfaces. Further, the example presented in FIG. 1 shows a treadmill, but this embodiment of the invention could alternately comprise an exercise bicycle, an elliptical machine, or any other piece of equipment known in the art whose use might be enhanced by the logging of biometric data or the manipulation of parameters based on biometric data.

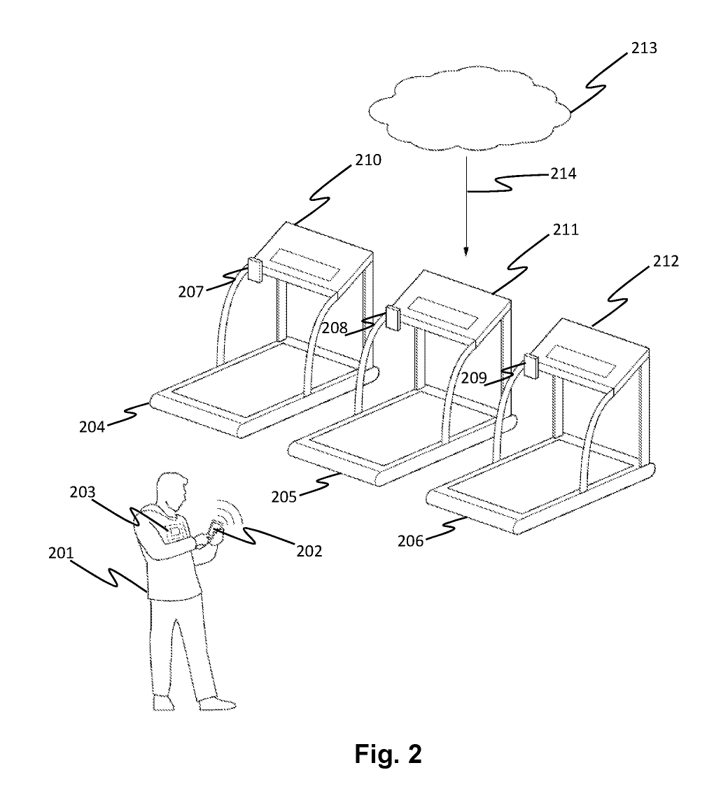

Referring now to FIG. 2, another embodiment of the invention is shown. The example of FIG. 2 is similar to that of FIG. 1, but the example of FIG. 2 illustrates how FIG. 1 might work in a facility with multiple treadmills or other exercise equipment. A user 201 approaches a bank of three treadmills, 204, 205, and 206, with the intention of using treadmill 205. Each treadmill is equipped with a beacon 207-209. Each treadmill is also equipped with a display screen 210-212. User 201 is carrying a smartphone 202 and at least one biometric sensor 203. As user 201 approaches the bank of treadmills, her smartphone 202 detects the signals of all three beacons 207-209.

In some embodiments the smartphone 202 is able to discern that the signal strength from the beacon 208 (corresponding to treadmill 205) is the strongest, and thus is able to infer with a degree of confidence that the user is about to use treadmill 205. In other embodiments, the smartphone 202 is unable to discern with confidence which of the signals from the beacons 207-209 is the strongest. In this scenario, the user 201 reverts to any of a number of second factors to indicate which treadmill she is approaching. In some embodiments, the second factor is a Near-Field Communication (NFC) tap. In other embodiments, the user 201 selects the treadmill 205 from a list presented on her smartphone 202. In other embodiments, the smartphone 202 communicates with a server over the Internet 213 and determines, based on the time that the treadmill started, the treadmill speed, and the user's running pace, that the user 201 has started running on treadmill 205. In some embodiments, a depth sensor or other camera-based computer vision system may be used to detect the gait or other physical characteristics of user 201 and compare that data to a set of known profiles in order to determine that user 201 is approaching treadmill 205. In some embodiments, the display 211 presents the user 201 with a QR code or alphanumeric sequence, which the user 201 may photograph with or enter into her smartphone 202.

Regardless of whether or not the user 201 is required to use a second factor to indicate which treadmill she is using, once the indication has been made, the smartphone 202 and the treadmill 205 are considered virtually paired. The server forms a bi-directional data link 214 whereby the smartphone 202 may share biometric data with the treadmill 205. The treadmill 205 may use this biometric data either to display on the display panel 211 or to adjust the intensity of the user's 201 workout. Similarly, the treadmill 205 may share information with the virtually-paired smartphone 202, to record on a fitness app the duration, intensity, incline, or other parameters of the workout. In some embodiments the user 201 stores workout preferences on the smartphone 202 or in a fitness app. In some embodiments, the smartphone is able to share the workout preferences of a user 201 with a treadmill 205 in order to automatically load a user's desired workout routine into the treadmill 205. In some embodiments, display panel 211 comprises a view of a virtual environment for user 201 to interact with, wherein parameters of the virtual environment correspond to biometric data received from smartphone 202.

Referring now to FIG. 3, system 300 of another embodiment of the invention is shown. In this example, two users 301 and 302 are standing in two different rooms 304, 305 of a structure 303. In the example shown, a first beacon 306 is positioned in bathroom 304 and a second beacon 307 is positioned in a bedroom 305. User 301 is equipped with at least one sensor, such as biometric sensors 309 and 310, and also a network enabled device, such as a smartphone 308. User 302 is equipped with biometric sensors 312 and 313, and also a smartphone 311. In this example, sensor 309 is a heart rate monitor and the sensor 310 is an accelerometer. In this example, the users 301 and 302 have their heart rates and movements within the structure 303 tracked. In the example system 300, smartphone 311 collects signals from beacons 306 and 307. In some embodiments, smartphone 311 additionally collects and aggregates data from GPS, cellular towers, wi-fi, and any other available data relevant to user's 302 location. Smartphone 311 then transmits the data collected to server 315 via Internet 314. From this information, server 315 determines that user 302 is most likely in bedroom 305. As configured on or determined by server 315, users determined to be in bedroom 305 are considered at lower risk for injury, such as the chance of a slip-and-fall accident. Server 315 therefore signals smartphone 311 to place biometric sensors 312 and 313 in a low-power mode. In the low-power mode, biometric sensors 312 and 313 report data less frequently and/or with lower precision, in order to conserve power and storage space on server 315. Because user 302 is determined to be in a lower-risk area of structure 305, frequent reporting of biometric data is less important than conserving battery life of sensors 312 and 313.

In some embodiments, system 300 further comprises a machine learning or other algorithm for determining risk profiles based on characteristics of individual users, for example medical history and age, and also based on characteristics of physical locations. The system 300 may then use the risk profile developed to assign data rates and transmit rates to the one or more sensors in use by the one or more users. In some embodiments, the risk profile is determined by server 315 based on data received. In other embodiments, the risk profile may be adjusted entirely by smartphone 311 without communication with server 315.

By contrast, when smartphone 308 sends its aggregated data to server 315, server 315 determines that user 301 is most likely in bathroom 304. As configured on server 315, the bathroom is considered a high-risk area for slip and fall accidents, and so server 315 signals smartphone 308 to place biometric sensors 309 and 310 into a higher-power, higher precision mode. In this higher precision mode, battery life is sacrificed to produce more frequent readings and transmissions of data to server 315. In this way, server 315 will be able to more quickly determine whether user 301 has suffered an accident. In some embodiments, server 315 is configured to detect a sudden change in user 301's heart rate. In some embodiments, server 315 is configured to detect a sudden acceleration event from an accelerometer. In other embodiments, server 315 generates an alert when there is no movement detected from any of a variety of biometric or wearable sensors used by user 301. In some embodiments, biometric data gathered from sensors 309 and 310 is analyzed on network-enabled device 308 before transmission to server 315. In some embodiments, if an alert condition is detected, network-enabled device 308 may override the location-based data rules. Examples of alert conditions include sudden changes in heart rate, sudden movements detected by an accelerometer, stress detected via galvanic skin response, or any other biometric-based warning signs known in the art. In some examples, network-enabled device 308 may override the location-based data rules permanently. In other examples, the network-enabled device may override the rules temporarily for a fixed or alert-dependent period of time. In some embodiments, the server may reset or override an alert condition on a network-enabled device.

In some embodiments, when server 315 determines that an accident has occurred with user 301, it may alert user 302 by placing a phone call to user 302's smartphone. In other embodiments, server 315 may alert user 302 via text message. In other embodiments, server 315 may have access to a siren or other alarm present in the house, and may activate the siren or other alarm in order to alert some or all inhabitants of structure 303 that an accident has occurred. In other embodiments, the server may alert the administrator of a care facility or other individual caring for users 301 and 302. In still other embodiments, server 315 may call emergency services to alert police, fire, or an ambulance company that user 301 is injured. In some embodiments, server 315 may ask for a verbal or other confirmation in order to determine whether the detected accident is real or is a false alarm. In other embodiments, anyone in the house may be able to provide a verbal or other confirmation as to the legitimacy of any user's detected accident. In some embodiments, user 302's smartphone may activate the built-in camera or microphone to initiate audio/visual communication with user 302. In some embodiments, server 315 or user 302's smartphone may modify lighting conditions in one or more rooms of structure 303, either by switching lights on or off or by changing the color of lights, if possible, in order to indicate the detection of an accident or user 302's detected state of health.

In some embodiments, tracking is confined to certain structures, and all sensors change to a low-power state when users 301 or 302 leave structure 303. In some embodiments, users who are determined to be not moving when in bedroom 305 during normal sleeping hours are determined to be in a sleeping state, and some or all of the biometric sensors are put into a deep sleep mode to conserve battery power. In some embodiments, the user 302 may be a caregiver or other individual capable of helping a user 301 in the case of an accident. In some embodiments, caregiver's network-enabled device 311 may act as a location beacon, for example, allowing device 308 to detect that caregiver 302 is in close proximity. In some embodiments, the presence or proximity of a caregiver 302 may trigger network-enabled device 308 to place sensors 309 and 310 in low-power state, because the presence of caregiver 302 means the risk of an accident is lower. In some embodiments, the presence or proximity of a caregiver 302 may trigger network-enabled device 308 to relay biometric data from user 301 to a mobile device of caregiver 302, allowing caregiver 302 to see current vital signs of user 301. Additionally, when network-enabled device 308 detects that caregiver 302 is no longer in close proximity, device 308 may resume normal operation based on its location.

The example scenario describing the bedroom and bathroom is not meant to be limiting, and it is understood that different buildings and environments may have different location-based risk profiles that dictate more, less, or different kinds of data flow from different sensors based on a user's location. For example, in some embodiments, some or all biometric sensors may switch to a higher precision mode as a user approaches a staircase. In some embodiments, some or all biometric sensors may switch into low-power mode when a user is immobile for a long time in a chair in front of a TV. In some embodiments, a beacon may be placed in a particularly dangerous area of a warehouse, and entry into that dangerous area may place a user's biometric sensors into a higher-precision mode. In other embodiments, a supervisor may be notified when a worker is detected entering a dangerous area.

In some embodiments, a beacon may be attached to an object or piece of equipment. For example, biometric sensors may be placed in high precision mode when a user picks up a chainsaw or approaches a ladder equipped with a beacon. In some embodiments, biometric sensors may be placed in high precision mode when a user approaches a traditionally dangerous vehicle such as an ATV or dirt bike. In some embodiments, livestock that could be considered dangerous are equipped with beacons to adjust the risk profile of users who approach them. In some embodiments, beacons may be placed in emergency stairwells in order to adjust a user's risk profile during a fire or other emergency. In other embodiments, ephemeral tags are used for rapidly evolving, dangerous, geographically-based situations such as mass shootings or earthquakes.

Although beacons may be described in certain embodiments of the present invention as wireless devices in unidirectional or bidirectional wireless communication with one or more client devices, it is understood that some or all of the functions of the beacon may be performed by other systems. For example, in one embodiment, a beacon may comprise a QR code or augmented reality (AR) code positioned on a wall or otherwise near the user. The code could then be detected via a camera, for example a camera mounted on glasses or integrated into a smartphone. The detection of the code could then provide the necessary context to alter a data rate or another parameter of a system of the present invention. In another embodiment, the identifying information of a beacon may comprise the inherent properties of the room or space in which the user is currently standing. For example, if a user enters a room wearing a HoloLens or other camera/depth sensor capable of generating a point cloud defining a three-dimensional space, the resulting point cloud could be used to identify the type of room or context which the user is entering. In some embodiments, RGB color data about the room or the contents of the room may also be used. In some embodiments, systems of the present invention may use machine learning to compare a never-before seen room or context to a database of existing rooms or context, in order to make a determination about the type of room or context the user has entered.

In some embodiments, other outside information may be used to increase or decrease the data rate from a set of biometric sensors. For example, weather reports indicating high or low temperature extremes in an area, combined with a determination that a user is outside or in a non-climate-controlled room, may change the data rate of a set of sensors to increase monitoring of a user. In other embodiments, local extreme weather events such as blizzards, tornadoes, or hurricanes may increase the data rate of a user's set of sensors. In another embodiment, presumed icy conditions may change the data rate of a user's set of sensors as the user approaches the front door.

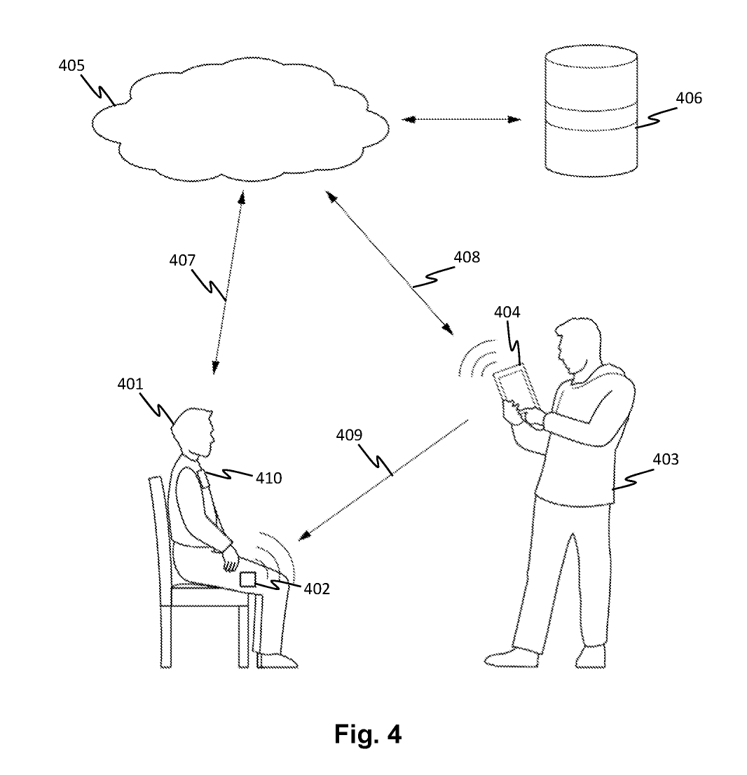

Referring now to FIG. 4, another embodiment of the invention is shown. In this example, a patient 401 is equipped with a smartphone 402 and at least one biometric sensor 410. A physician 403 arrives to examine patient 401, carrying a tablet computer 404. Though the physician 403 uses a tablet computer in this example, the physician could use any portable computer known in the art, including but not limited to a laptop, a smartphone, or a specialized portable medical computing device. Upon arrival in the examination room, the tablet computer 404 acts as a beacon, sending a short range broadcast signal 409. The smartphone 402 receives the short-range broadcast signal 409 and is able to discern with confidence that the patient 401 is about to be examined by a physician 403 carrying the tablet computer 404. The smartphone 402 then transmits a signal to a server 406 over the Internet 405, so that both the tablet 404 and the smartphone 402 are aware of the virtual pairing relationship that has been formed. In some embodiments, a second factor confirmation is required on one or both of the tablet 404 and the smartphone 402 before the virtual pairing relationship is formed.

Once the virtual pairing relationship is formed, in some embodiments, the server 406 accesses the patient's 401 electronic medical records (EMR) and relays some or all of the medical records to the tablet 404 in order to assist with the physician's 403 examination. In some embodiments, the smartphone 402 will transmit the biometric data collected from the one or more biometric sensors 410 over a secure connection 407 to the server 406, which will then relay the data via a secure connection 408 to the tablet computer 404. In some embodiments, the tablet 404 is able to place the one or more biometric sensors 410 in a high-precision mode or a low-power mode. In some embodiments, an additional level of authentication is required for the physician 404 to exercise any control over the patient 401's smartphone 402 or biometric sensors 410. In one example, patient 401 is a runner or participant in an endurance event such as a marathon. Physician 403 may be an aid worker at an aid station or standing at the sidelines of a race. Smartphone 402 may transmit biometric data from runner 401 to tablet computer 404 either when runner 404 enters the aid station seeking assistance, or in the latter case when runner 401 passes aid worker 403 along the sideline. In this way, aid workers can quickly and conveniently assess the health of participants in endurance events.

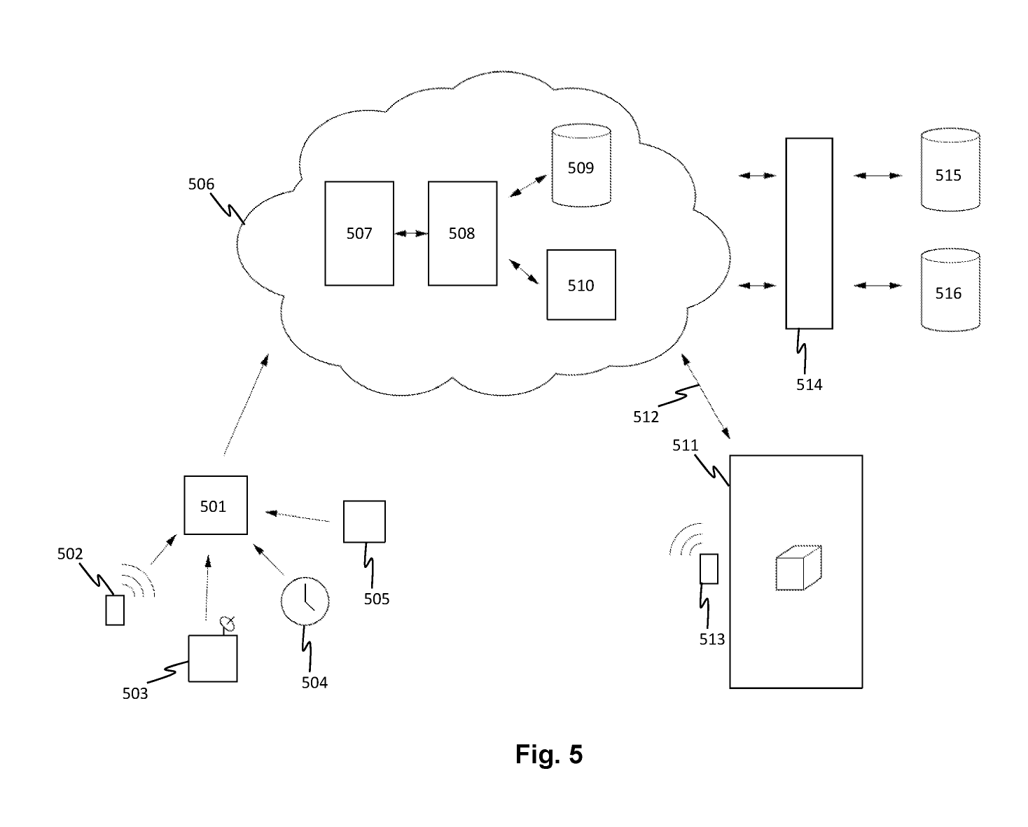

Referring now to FIG. 5, a data flow diagram of one example of a virtual pairing arrangement is shown. On one side is a client device 501, which in some embodiments is a smartphone, but can also be any device known in the art that is capable of wirelessly gathering data from an array of sensors and communicating with the Internet. The client device 501 accepts a variety of data types as client-local inputs. Examples are a wi-fi receiver 502, a GPS receiver 503, the time of day 504, and a heart rate monitor 505.

The data gathered by the client device is transmitted via the Internet 506 to an Internet of Things hub 507, which aggregates the data from client device 501 and other client devices. The aggregated client device data is then transmitted to an analytics engine 508, which performs mathematical and statistical analysis of the aggregated data. In some embodiments, some or all of the aggregated data may be stored in a secure data store 509. In some embodiments, the analytical data is also stored in the data store for easy retrieval. In some embodiments, some or all of the aggregated data and/or the analytics data may also be passed into a machine-learning interface 510.

In one embodiment, machine-learning interface 510 is used to compare patient outcomes in a physical-therapy setting. Patients complete different rehabilitation scenarios while client device 501 collects various biometric data, including volumetric motion data. Additionally, in some embodiments, analytics engine 508 may also collect data from one or more cameras aimed at the patients. Over time, analytics engine 508 will gather multiple patients' treatment and recuperation trajectories into data store 509 as they progress through physical therapy. Physicians tag the different data to determine which patients arrived at favorable outcomes and which patients suffered poor outcomes of their treatment methods. In some embodiments, automated tagging may be accomplished though integration with an Electronic Medical Records (EMR) system. Using the aggregated past data, machine learning interface 510 could form a prediction about a new patient, determining with some degree of confidence whether the new patient had an increased risk of a poor outcome.

In some embodiments, one or more virtually paired devices 511 may be granted access to some or all of the data from the client device 501, the data store 509, the analytics engine 508, and the machine learning interface 510, by virtue of at least the proximity of the client device 501 to the beacon 513. In some embodiments, the virtually paired device 511 may comprise one or more visualizations based on the data provided. In some embodiments, the virtually paired device includes a video game or virtual environment, whereby a user can manipulate parameters of the virtual environment or video game based on the data from the client device 501. The video game or virtual environment may be presented to the user on a display panel in a horizontal or vertical orientation, or alternatively via a head-mounted display or any other display technology known in the art. In some embodiments, audio or tactile responses may also be provided by the virtually paired device, optionally based on the inputs from the one or more biometric sensors. In some embodiments, the user can manipulate the parameters of the virtual environment of the video game based on heart rate or any other data made available from a range of biometric sensors or other data sources accessible to the client device 501.

In certain embodiments, the invention may include one or more EMR databases 516. The EMR database or databases may be incorporated into the data store 509, or administered by the same authority as the overall system, or alternatively may be owned and administered by a third party hospital or care provider. In the latter case, the biometric analysis system may communicate with the EMR via any of a wide variety of web-based or local system application programming interfaces (APIs). In one embodiment, the biometric data collection and processing system communicates with at least one EMR database via a Representational State Transfer (REST or RESTful) API. In some embodiments, the system communicates with other web- or cloud-based services via a REST or other API.

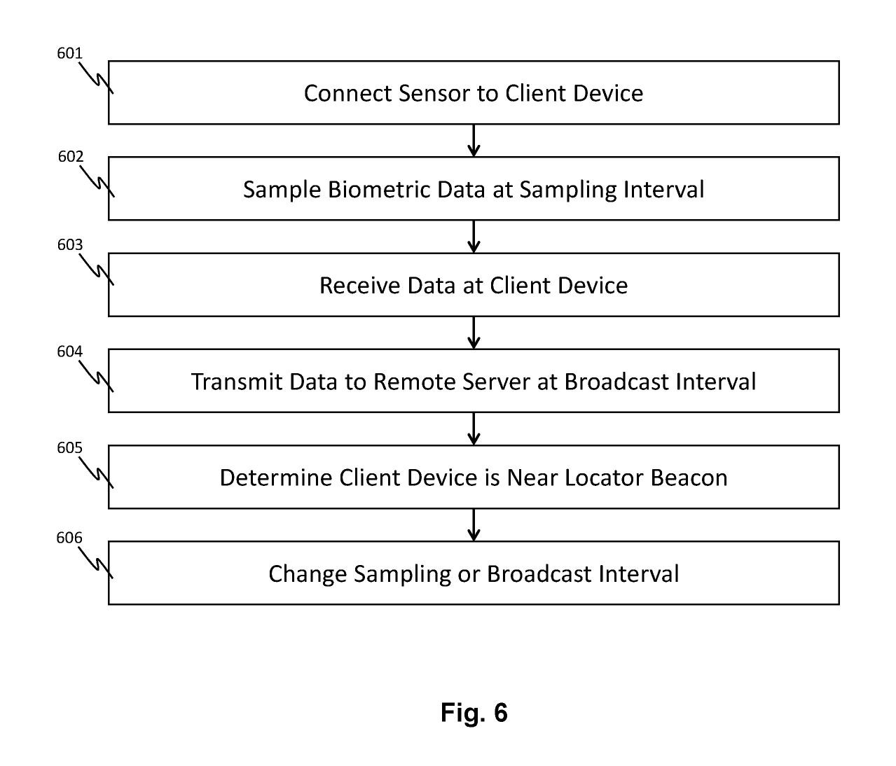

With reference now to FIG. 6, a method of collecting and analyzing biometric data is shown. The method comprises the steps of connecting at least one biometric sensor to a client device capable of wireless communication 601, sampling an element of biometric data from a client at a biometric data sampling interval 602, receiving elements of biometric data from the at least one biometric sensor to the client device at a biometric data broadcast interval 603, transmitting elements of biometric data from the client device to a remote server 604, determining that the client device is in close proximity to a locator beacon 605, and changing at least one of the biometric data sampling interval and the biometric data broadcast interval 606.

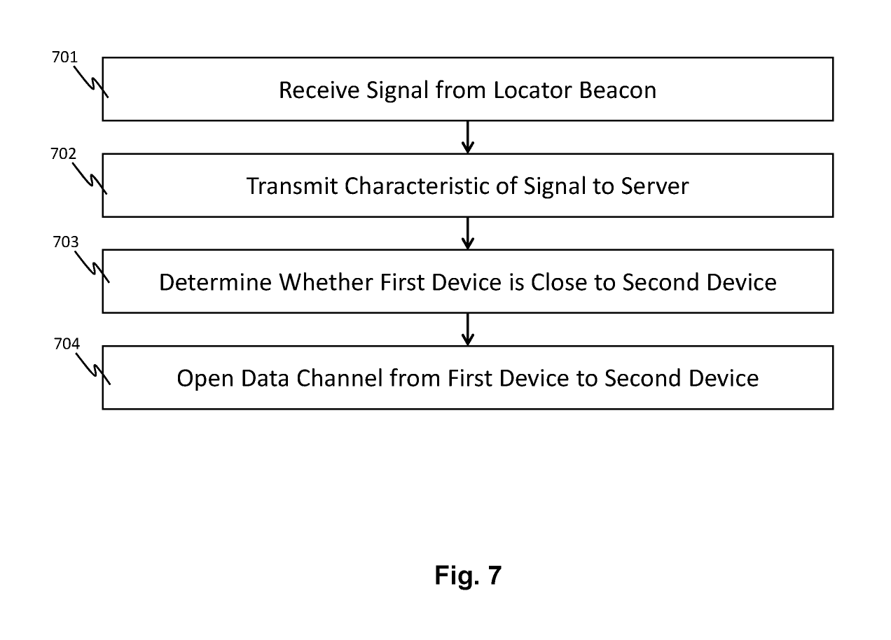

With reference now to FIG. 7, a method of virtually pairing a first device with a second device is shown. The method comprises the steps of receiving, on a first device, a signal from a locator beacon 701, transmitting, from the first device, a characteristic of the signal to a remote server 702, determining, based on the characteristic of the signal, whether the first device is in close proximity to a second device 703, when the first device is determined to be in close proximity to the second device, and opening a data channel from the first device to the second device, via the remote server 704.

### Methods of Use

The invention disclosed herein also includes a method of use. In some embodiments, the method of use comprises the steps of connecting a client mobile device to one or more biometric sensors, some of which may be worn by a user. In some embodiments, some or all of the one or more biometric sensors are contained entirely or partially within the client mobile device. The client mobile device then begins collecting data from the one or more biometric sensors at a first sampling interval to transmit data to a remote database at a first transmission interval. The client mobile device periodically checks whether it can detect proximity to any of a set of location beacons. Upon detecting proximity to one or more location beacons, the client mobile device transmits its determined location to a remote database. Based on the determined location transmitted, the remote database transmits a signal to the client mobile device, which then reconfigures some or all of the one or more biometric sensors to sample at a second sampling interval, which may be higher or lower than the first sampling interval. The client mobile device may alternatively change its own transmission rate of data to the remote database to a second transmission interval, which may be higher or lower than the second transmission interval.

In other embodiments, the remote database may change one or more access permissions to stored or incoming biometric data based on the determined location transmitted. In other embodiments, the data from the one or more biometric sensors may be used as a control input to a video game or interactive virtual environment. In some embodiments, the data from the one or more biometric sensors may be overlaid on a display panel or head-mounted display. The biometric data may alternatively be used as part of an augmented reality experience, i.e. wherein biometric data is overlaid on a display that is somehow indicative of a user's real surroundings.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A system for biometric data collection and processing comprising:
at least one biometric sensor associated with a user, the at least one biometric sensor having a biometric data sampling interval and a data broadcast interval;
a client device capable of wireless communication and communicatively connected to the at least one biometric sensor; and
at least one locator beacon;
wherein, when the client device wirelessly receives a signal from the locator beacon, the client device changes at least one of the data broadcast interval and the data sampling interval.

2. The system of claim 1, further comprising a remote server;
wherein the client device sends data received from the at least one biometric sensor to the remote server once per data broadcast interval.

3. The system of claim 1, further comprising an exercise machine;
wherein the exercise machine and the client device are virtually paired.

4. The system of claim 3, wherein the exercise machine comprises a treadmill.

5. The system of claim 1, further comprising a machine learning module;

6. The system of claim 1, further comprising a virtual environment having at least one parameter;
wherein the virtual environment changes the at least one parameter in response to data received from the at least one biometric sensor.

7. The system of claim 1, further comprising a display device;
wherein the display device and the client device are virtually paired; and
wherein the display device presents data received from the at least one biometric sensor.

8. The system of claim 7, wherein the display device is also granted access to data about a client associated with the client device;
wherein the access is revoked when the client device and the display device are no longer virtually paired.

9. The system of claim 8, wherein the data about the client comprises electronic medical records.

10. The system of claim 1, further comprising:
wherein the at least one locator beacon comprises a first locator beacon positioned in a first location and a second locator beacon positioned in a second location;
the system further comprising a first risk profile associated with the first locator beacon and a second risk profile associated with the second beacon, the risk profiles defining at least one signaling rule;
wherein, when the client device wirelessly receives a signal from the first locator beacon, the client device changes at least one of the data broadcast interval and the data sampling interval according to the at least one signaling rule defined by the first risk profile; and
wherein, when the client device wirelessly receives a signal from the second locator beacon, the client device changes at least one of the data broadcast interval and the data sampling interval according to the at least one signaling rule defined by the second risk profile.

11. The system of claim 10, wherein the second risk profile denotes a second location that is more hazardous than the first location;
wherein the at least one signaling rule of the second risk profile causes the client device to decrease at least one of the data broadcast interval and the data sampling interval in response to the signal received from the second locator beacon.

12. The system of claim 11, wherein the second location is a bathroom in a dwelling.

13. The system of claim 10, wherein the client device further comprising a third risk profile defining at least one signaling rule associated with an external condition;
wherein a remote server transmits the third risk profile to the client device when the external condition is met; and
wherein, when the client device wirelessly receives the third risk profile from the remote server, the client device changes at least one of the data broadcast interval and the data sampling interval according to the at least one signaling rule defined by the third risk profile.

14. The system of claim 13, wherein the external condition comprises a high likelihood of icy weather conditions.

15. A method of collecting and analyzing biometric data, comprising:
connecting at least one biometric sensor to a client device capable of wireless communication;
sampling an element of biometric data from a client at a biometric data sampling interval;
receiving elements of biometric data from the at least one biometric sensor to the client device at a biometric data broadcast interval;
transmitting elements of biometric data from the client device to a remote server;
determining that the client device is in close proximity to a locator beacon; and
changing at least one of the biometric data sampling interval and the biometric data broadcast interval.

16. The method of claim 15, further comprising virtually pairing a display device with the client device.

17. The method of claim 16, wherein the display device is a tablet computer.

18. The method of claim 16, wherein the display device is a head-mounted display.

19. The method of claim 15, further comprising changing at least one parameter of a virtual environment based on an element of biometric data received from the client device.

20. The method of claim 15, further comprising:
virtually pairing a piece of exercise equipment with the client device;
transmitting at least one parameter from a piece of exercise equipment to the remote server; and
storing the at least one parameter from the piece of exercise equipment in a database corresponding to the at least one element of biometric data received from the client device.

21. A method of virtually pairing a first device with a second device, comprising:
on a first device, receiving a signal from a locator beacon;
from the first device, transmitting a characteristic of the signal to a remote server;
determining, based on the characteristic of the signal, whether the first device is in close proximity to a second device;
when the first device is determined to be in close proximity to the second device, opening a data channel from the first device to the second device, via the remote server;
wherein the first device and the second device are capable of exchanging data over the data channel without direct wireless communication.

22. The method of claim 11, wherein the second device is electrically connected to the locator beacon.

23. The method of claim 21, further comprising the step of:
after the first device is determined to be in close proximity to the second device, presenting a user of the first device or the second device with a verification step to confirm that a virtual pairing connection is desired.
